(19) United States
(12) Patent Application Publication
(10) Pub. No.: US 2005/0084349 A1
(43) Pub. Date: Apr. 21, 2005

(54) Drilling tool

(76) Inventors: Karl Kammerer, Fluorn-Winzeln (DE); Willi Schillinger, Baiersbronn (DE)

Correspondence Address: Pauley Petersen & Erickson, 2800 W Higgins Road, Suite 365, Hoffman Estate, IL, 60195, US

(21) Appl. No.: 10/504,356

(22) PCT Filed: Dec. 28, 2002
(86) PCT No.: PCT/EP02/14788

(30) Foreign Application Priority Data
Feb. 12, 2002 (DE) 10205644,7

(51) Int. Cl. B23B 51/04

(52) U.S. Cl. 408/204

(57) ABSTRACT

A drilling tool having a drill bit with an annular base body that can be fixed to a hollow cylindrical drill pipe. The base body has tool recesses distributed around the circumference of the side facing away from the drill pipe and which hold interchangeable cutting teeth, the tool head of the teeth projecting in an axial direction above the base body. A shaft, which is mounted in a shaft cavity of the tool recess, is coupled to the tool head. This invention provides an optimized tool in terms of technology and resistance to wear. To achieve this, the shaft is mounted in an insertion channel of the shaft cavity, the insertion cavity terminates in an opening, which accommodates a nut, the shaft has a threaded section that projects into the opening and is screwed into the nut and the cutting tooth is held in a prestressed manner against one or more supporting surfaces of the tool recess.

### BACKGROUND OF THE INVENTION

1. Field of the Invention

This invention relates to a drilling tool having a drill bit, with an annular base body, which is securable to a hollow drill pipe, wherein the base body has a tool receiver, which is distributed around a circumference on a side facing away from the drill pipe and on which cutting teeth of the tool receiver are retained in an interchangeable manner, the cutting teeth extend in the axial direction above the base body with a tool head, a shaft is mounted on the tool head and the shaft is inserted into a shaft receiver of the tool receiver and is connected to the base body, and the cutting tooth is retained in a pretensioned manner via support faces on the base body.

2. Discussion of Related Art

A drilling tool is known by German Patent Reference DE 36 19 334 A1. In this case, the drill bit has an annular base body welded to a drill pipe or a coupling. The base body supports integrally formed tooth projections which are distributed at a spacing around the circumference, and tooth tips are welded on the tooth projections in a replaceable manner.

If the tooth tips become worn, then extensive and time-consuming removal and mounting welding work is necessary to repair the drilling tool. This is particularly applicable when individual tooth tips have to be replaced in order to resume drilling. In many cases, for reasons of cost, it can be more advantageous to replace the entire drill bit.

German Patent Reference DE 39 338 67 C2 teaches a solution for exchanging the drill bit on the drill pipe. However, even in this case a steel ring in the form of the base body is welded to the drill pipe.

As German Patent Reference DE 39 41 601 C1 shows, drill heads are also known for producing drill holes, where the drill heads with an integrally formed portion are insertable into the receiver of a shaft, which is connectable to the drill pipe, and are retained therein by a retaining pin. Operating under harsh conditions, a deterioration in the support of the drill head in the shaft must be expected over time and this is manifested as a deterioration in the performance of the drill and in increased wear of the drill head.

The interchangeability of the cutting teeth in the case of a cutting bit for drill pipes is taught by PCT International Publication WO 98/19814 A1. The cutting teeth are inserted in recesses of the drill pipe and are retained by a screw-connection.

### SUMMARY OF THE INVENTION

It is one object of this invention to provide a drilling tool of the type described above but where the cutting teeth are not only mounted on the base body to be replaceable but where it is possible to adapt, control and possibly adjust the retention of the cutting teeth in the base body, depending on the wear.

The above object and others are achieved according to this invention with a tool receiver that has mounting projections, which protrude above the base body in a direction of the axis of rotation and which are disposed separated from one another via a spacing which extends around the circumference. The cutting teeth rest with their tool head on the mounting projections and extend above the mounting projections in the axial direction. The mounting projections have support faces in the circumferential direction on both sides of the shaft receiver. The support faces are set to face one another and to be at an angle relative to the axis of rotation of the drill bit, and the cutting tooth rests with mating faces on the support faces to be adjustable.

Thus, with the tool receiver in the base body and the pre-tensioning of the cutting tooth, in the event of wear occurring during drilling, it is possible to adjust the cutting tooth axially so that the retention and the support at the base body remain constant.

At the same time, the pre-tensioning can be adjusted periodically if in the region of the tool receiver the base body has axial, oval insertion channels for the shafts which are integrally formed on the tool head. The cutting teeth are provided with an integrally formed threaded portion adjacent to the shaft. In the region of the threaded portion of the cutting teeth inserted into the tool receiver the base body has radial openings for nuts, which are screw-connectable to the threaded portions. The nuts are freely rotatable in the openings and do no extend at the circumference above the circumferential outline of the annular base body. The cutting tooth is retained in a pretensioned manner in the tool receiver by the screw connection produced from threaded portion and nut.

It is possible to deflect the drill chips passing between the cutting teeth into the spaces because the outsides of the two mounting projections of one tool receiver which face away from one another, in the form of deflecting faces, are at an angle relative to the axis of rotation of the drill bit and are inclined opposite one another. Also, the spaces are formed by webs and because the webs pass over continuously into the inner wall of the base body via inclined faces, wherein the inclined faces are at an angle relative to the axis of rotation of the drill bit.

In one embodiment having good deflecting of drill chips, the deflecting faces of the mounting projections pass over into the inclined faces and one end face of the webs, wherein the end faces are adjacent to the inclined faces at an angle and proceed in the radial direction towards the outer wall of the base body.

The drill performance can be improved even more because the base body, on its outer circumference and/or its inner circumference, has projections which protrude in the radial direction on the base body. The projections support at least one element produced of hard metal for protection against wear. The disposition, in this case, can be such that, in the region of the spaces with the webs, the projections are orientated in the direction of the axis of rotation of the drill bit. If the openings in the base body continually widen from the inner wall of the base body to the outside of base body, it can then be easy to access and rotate the nut from the outside of the base body.

### BRIEF DESCRIPTION OF THE DRAWINGS

This invention is described in more detail in view of an embodiment represented in the drawings, wherein:

FIG. 1 is a side view of a drill bit;

FIG. 2 is a perspective view of the drill bit shown in FIG. 1;

FIG. 3 is a vertical section view of the drill bit;

FIG. 4 is a detailed representation of the view shown in FIG. 3; and

FIG. 5 is a side perspective view of a cutting tooth.

### DESCRIPTION OF PREFERRED EMBODIMENTS

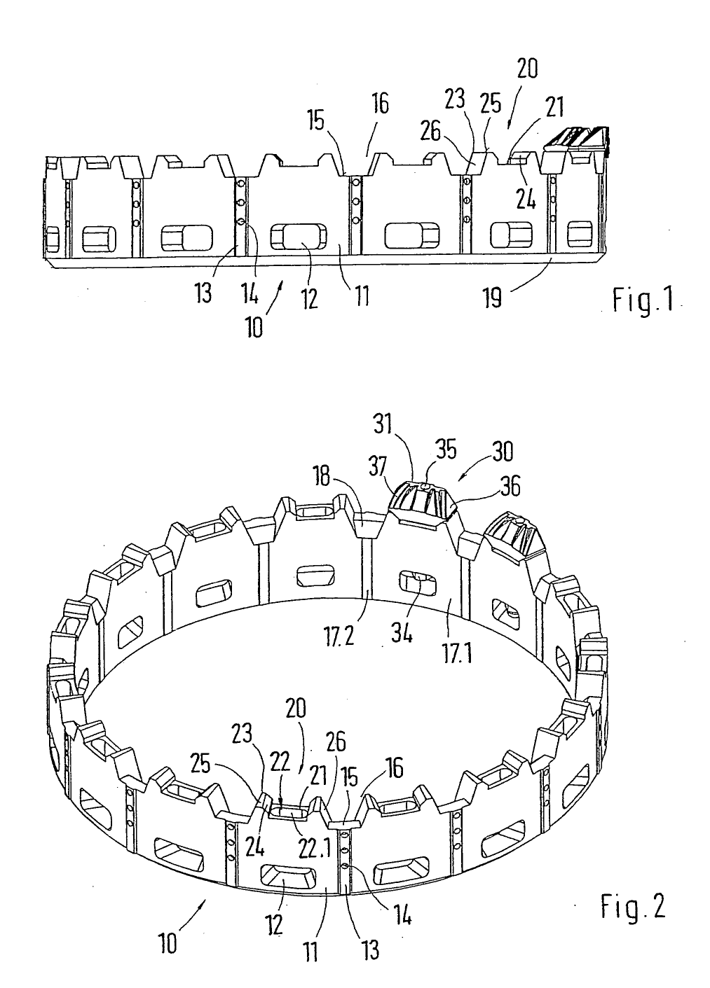

FIGS. 1 and 2 show a drill bit 10, which is produced in one piece from a casting. It is annular and has a base body 11 that has on a lower edge a securing ring 19 in the form of a mounting. On a side remote from the securing ring 19, mounting projections 21 are integrally formed around the circumference on the base body 11. The mounting projections 21 are spaced equally from one another to produce a space 16. The base body 11 has webs 15 between the mounting projections 21. The webs 15 each form an end face which extends in the radial direction. All end faces of the webs 15 rest on a common plane. Inclined faces 18 proceed from the end faces at angle. The inclined faces 18, in this case, are facing the interior, which is surrounded by the drill bit 10. The end faces and the inclined faces 18 pass over at their circumferential ends into deflecting faces 26 of the mounting projections 21. The deflecting faces 26 project above the end faces in the direction of the axis of the drill bit. The deflecting faces 26 each pass over into a roof portion 25 that passes over into a support face 24. The support face 24, in this case, is disposed at an angle to the horizontal. The two support faces 24 of one mounting projection 21, in this case, are aligned opposite one another and are part of a tool receiver 20. The tool receiver 20 has a shaft receiver 11, which has an oval cross-section, with an insertion channel 22.1 between the two support faces 24. The insertion channel 22.1 ends in an opening 12 and is machined into the base body in the shape of a window. The opening 12, in this case, widens outwardly in a continuous manner proceeding from the inner wall 17.1 of the base body 11.

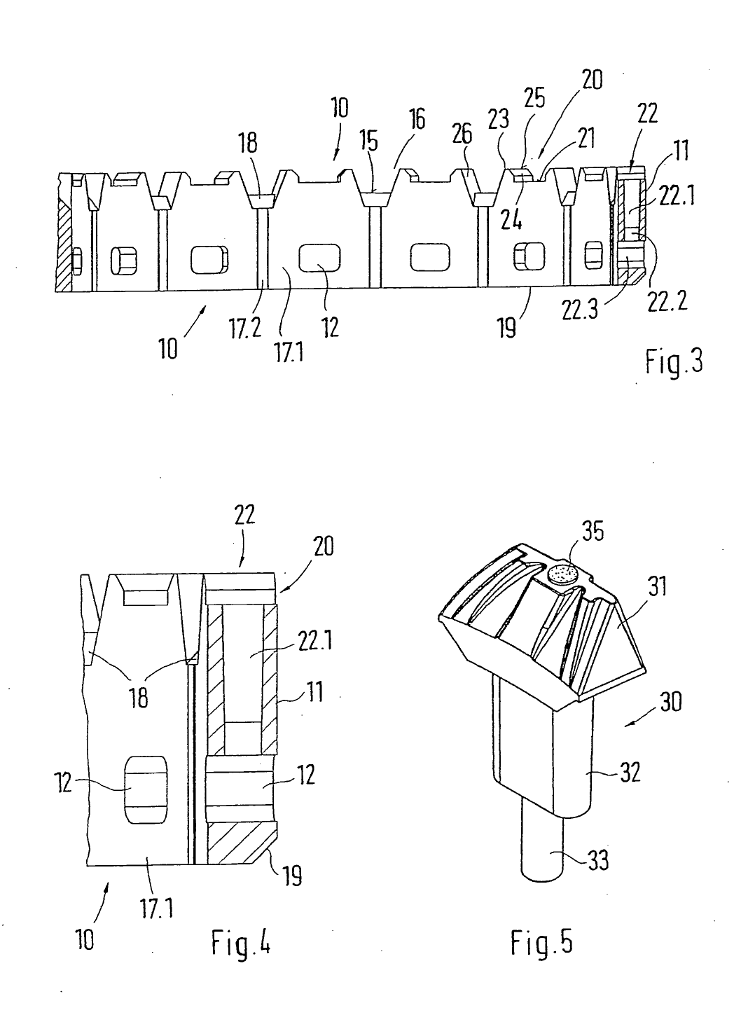

The disposition and development of the insertion channel 22.1 and of the opening 12 is shown in FIGS. 2 and 4.

As shown in FIG. 2, cutting teeth 30 can be inserted into the tool receiver 20. The development of the cutting teeth 30 is shown in FIG. 5. According to FIG. 5, the cutting teeth 30 have a tool head 31, on which a shaft is integrally formed. The tool head has hard metal inserts 35 and at a free end the shaft 32 has a threaded portion 33.

The cutting tooth is inserted with its shaft 32 into the insertion channel 22.1. In the installed state, the cutting tooth 30 rests with corresponding mating faces on the support faces 24.

The threaded portion 33 extends into the region of the opening 12, so that a nut 34 can be screw-connected. The cutting tooth 30 can be tensioned on the support faces 24 with the nut 34. As the cross-sectional geometry of the shaft 32 of the cutting tooth 30 is adapted to the outline of the insertion channel 22.1, it is retained in a non-rotatable manner. As shown in FIG. 1, the cutting tooth 30 has two shaped faces 36, which pass over into the deflecting faces 26 of the support parts 25 in a seamless manner.

To calibrate the drill bit 10, projections 13 are disposed on the outer face of the base body 11 and have elements 14 produced from hard metal for protection against wear.

In the region of the inner wall 17.1, the base body 11 also has projections 17.2, which extend into the interior of the drill bit 10 and optimize protection against wear at that location.

1. A drilling tool having a drill bit (10), with an annular base body (11), securable to a hollow cylindrical drill pipe, wherein the base body (11) has a tool receiver (20), distributed around a circumference on a side facing away from the drill pipe and on which cutting teeth (30) are retained in an interchangeable mannner, the cutting teeth (30) extend in an axial direction above the base body (11) with a tool head (31), a shaft (32) is mounted on the tool head (31), the shaft (32) is inserted into a shaft receiver (22) of the tool receiver (20) and is connected to the base body (11), and the cutting teeth (30) are retained in a pretensioned manner via support faces (24) on the base body (11), the drilling tool comprising: the tool receiver (20) having mounting projections (21), extending above the base body (11) in a direction of a rotation axis and disposed separated from one another via a spacing (61) extending around the circumference, the cutting teeth (30) each resting with a tool head (31) on the mounting projections (21) and extending above the mounting projections (21) in the axial direction, the mounting projections (21) having support faces (24) in a circumferential direction on both sides of the shaft receiver (22), the support faces (24) facing one another and at an angle relative to the rotation axis of the drill bit (10), and the cutting teeth (30) resting with mating faces on the support faces (24) in an adjustable manner.

2. The drilling tool according to claim 1, wherein in a region of the tool receiver (20) the base body (11) has axial oval insertion channels (22.1) for the shafts (32) which are integrally formed on the tool head (31), the cutting teeth (30) each has an integrally formed threaded portion (33) adjacent the shaft (32), near the threaded portions (33) of the cutting teeth (30) inserted into the tool receiver (20) the base body (11) has radial openings (12) for nuts (34) which are screw-connectable to the threaded portions (33), the nuts (34) are freely rotatable in the openings (12) and extend one of short of and up to the circumference above a circumferential outline of the annular base body (11), and the cutting tooth (30) is retained in a pretensioned manner in the tool receiver (20) by of the screw-connection produced from threaded portion (33) and the nut (34).

3. The drilling tool according to claim 2, wherein outsides of the two mounting projections (21) of the tool receiver (20) which face away from one another as, deflecting faces (26) are at an angle relative to the rotation axis of the drill bit (10) and are inclined opposite one another.

4. The drilling tool according to claim 3, wherein spaces (16) are formed by webs (15) and the webs (15) pass over continuously into an inner wall (17.1) of the base body (11) via inclined faces (18), and the inclined faces (18) are at an angle relative to the rotation axis of the drill bit (10).

5. The drilling tool according to claim 4, wherein the deflecting faces (26) of the mounting projections (21) pass over into the inclined faces (18) and an end face of the webs (15), and the end faces are adjacent to the inclined faces (18) at an angle and proceed in a radial direction towards an outer wall of the base body (11).

6. The drilling tool according to claim 5, wherein the base body (11) on at least one of an outer circumference and an inner circumference has projections (13) which protrude in the radial direction on the base body (11), and the projections (13) support at least one element (14) of a hard metal for wear protection.

7. The drilling tool according to claim 7, wherein in the region of the spaces (16) with the webs (15), the projections (13) are directed toward the rotation axis of the drill bit (10).

8. The drilling tool according to claim 7, wherein the openings (12) in the base body (11) continually widen from the inner wall (17.1) of the base body (11) to the outside of the base body (11).

9. The drilling tool according to claim 1, wherein outsides of the two mounting projections (21) of the tool receiver (20) which face away from one another as deflecting faces (26) are at an angle relative to the rotation axis of the drill bit (10) and are inclined opposite one another.

10. The drilling tool according to claim 1, wherein spaces (16) are formed by webs (15) and the webs (15) pass over continuously into an inner wall (17.1) of the base body (11) via inclined faces (18), and the inclined faces (18) are at an angle relative to the rotation axis of the drill bit (10).

11. The drilling tool according to claim 3, wherein the deflecting faces (26) of the mounting projections (21) pass over into the inclined faces (18) and an end face of the webs (15), and the end faces are adjacent to the inclined faces (18) at an angle and proceed in a radial direction towards an outer wall of the base body (11).

12. The drilling tool according to claim 1, wherein the base body (11) on at least one of an outer circumference and an inner circumference has projections (13) which protrude in the radial direction on the base body (11), and the projections (13) support at least one element (14) of a hard metal for wear protection.

13. The drilling tool according to claim 12, wherein in the region of the spaces (16) with the webs (15), the projections (13) are directed toward the rotation axis of the drill bit (10).

14. The drilling tool according to claim 1, wherein radial openings (12) in the base body (11) continually widen from the inner wall (17.1) of the base body (11) to the outside of the base body (11).
